(19) United States
(12) Patent Application Publication
(10) Pub. No.: US 2025/0033518 A1
(43) Pub. Date: Jan. 30, 2025

(54) Charging Management for an Autonomous Electric Work Vehicles at a Worksite

(71) Applicant: Caterpillar Inc., Peoria, IL (US)

(72) Inventors: Thomas L. TWIGGER, Peoria, IL (US); Steven GAHLINGS, Peoria, IL (US)

(73) Assignee: Caterpillar Inc., Peoria, IL (US)

(21) Appl. No.: 18/715,806

(22) PCT Filed: Nov. 23, 2022
(86) PCT No.: PCT/US2022/050839

§ 371 Date: Jun. 3, 2024

(30) Foreign Application Priority Data
Dec. 3, 2021 (GB) 2117536.9

(51) Int. Cl. B60L 53/68; B60L 53/62; B60L 53/66

(52) U.S. Cl. CPC B60L 53/68; B60L 53/62; B60L 53/66; B60L 2200/40

(57) ABSTRACT

A method of charging management for a worksite comprising a plurality of autonomous electric work vehicles is provided. The method comprises communicating charger properties from a plurality of charging modules to a central controller and communicating vehicle properties from a plurality of electric work vehicles to the central controller. Charging is scheduled for the plurality of electric work vehicles based on the charger properties and the vehicle properties, wherein scheduling charging comprises assigning to each of the electric work vehicles a designated charging time and a designated charging module. Each electric work vehicle and its designated charging module are brought together at the designated charging time of the electric work vehicle.

### FIELD OF THE DISCLOSURE

The disclosure relates to the field of electric work vehicles.

### BACKGROUND

Large worksites typically have more than one charging point for electric work vehicles. The charging points may be at the same location or at different locations.

An autonomous electric work vehicle may travel to a charging point in order to charge without knowledge of any properties of the charging point, and so risk not being able to charge. For example, the charging point may be in use by another vehicle, low on power or charge, out of order, the wrong type of charging point, or otherwise unusable. In the event that an electric work vehicle cannot charge at the charging point, the electric work vehicle may be required to wait or to travel to a different charging point. Queues may develop, with electric work vehicles unnecessarily idle.

### SUMMARY OF THE DISCLOSURE

A method of charging management for a worksite comprising a plurality of autonomous electric work vehicles is provided. The method comprises communicating charger properties from a plurality of charging modules to a central controller. The method further comprises communicating vehicle properties from a plurality of electric work vehicles to the central controller. The method further comprises scheduling charging for the plurality of electric work vehicles based on the charger properties and the vehicle properties, wherein scheduling charging comprises assigning to each of the electric work vehicles a designated charging time and a designated charging module, wherein the designated charging module is one of the plurality of charging modules. The method further comprises bringing each electric work vehicle and its designated charging module together at designated charging time of the electric work vehicle. The charger properties comprise location of the charging module and availability of the charging module. The vehicle properties comprise a current state of charge of a battery of the electric work vehicle and a capacity of the battery of the electric work vehicle.

A charging management device for a worksite comprising a plurality of autonomous electric work vehicles is provided. The charging management device comprises a central controller. The charging management device is configured to communicate charger properties from a plurality of charging modules to a central controller. The charging management device is further configured to communicate vehicle properties from a plurality of electric work vehicles to the central controller. The charging management device is further configured to schedule charging for the plurality of electric work vehicle based on the charger properties and the vehicle properties, wherein scheduling charging comprises assigning to each of the electric work vehicles a designated charging time and a designated charging module, wherein the designated charging module is one of the plurality of charging modules. The charging management device is further configured to bring each electric work vehicle and its designated charging module together at designated charging time of the electric work vehicle. The charger properties comprise location of the charging module and availability of the charging module. The vehicle properties comprise a current state of charge of a battery of the electric work vehicle and a capacity of the battery of the electric work vehicle.

In this way, efficient charging of autonomous electric work vehicles may be scheduled. The example, queues for charging may be limited, and electric work vehicles may be prevented from travelling needlessly far to a charging module or to a charging module that is low on power or experiencing issues.

### BRIEF DESCRIPTION OF THE DRAWINGS

A specific embodiment of the disclosure will now be described, by way of example only, with reference to the accompanying drawings in which:

FIG. 1 shows a schematic diagram illustrating communication between a charging module and three electric work vehicles via a central controller, and negotiation between the electric work vehicles in accordance with an embodiment of the present disclosure.

### DETAILED DESCRIPTION

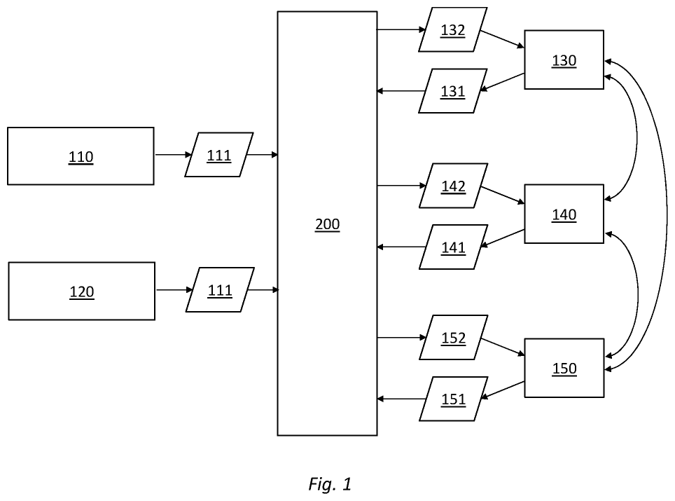

With reference to FIG. 1, a method of charging management for a worksite comprising a plurality of autonomous electric work vehicles 130, 140, 150 is illustrated. The method is illustrated with three electric work vehicles 130, 140, 150 and two charging modules 110, 120 as an example, but the worksite could comprise two or more than three electric work vehicles, and more than two charging modules. The method comprises communicating charger properties from a plurality of charging modules 110, 120 to a central controller 200. Vehicle properties are communicated from a plurality of electric work vehicles 130, 140, 150 to the central controller. Charging is scheduled for the plurality of electric work vehicles 130, 140, 150 based on the charger properties and the vehicle properties. Scheduling charging comprises assigning to each of the electric work vehicles 130, 140, 150 a designated charging time and a designated charging module, wherein the designated charging module is one of the plurality of charging modules 110, 120.

Each electric work vehicle and its designated charging module are brought together at the designated charging time of the electric work vehicle.

The charger properties comprise a location of the charging module and availability of the charging module. The vehicle properties comprise a current state of charge of a battery of the electric work vehicle and a capacity of the battery of the electric work vehicle.

A schedule 132, 142, 152 comprising the designated charging time and designated charging module for each electric work vehicle 130, 140, 150 may be communicated to each electric work vehicle 130, 140, 150 from the central controller 200.

Scheduling charging may be based on one or more of a priority assigned to each electric work vehicle; a state of charge of the battery of each electric work vehicle; a duration of charging required for each electric work vehicle; a proximity of each electric work vehicle to the charging module; and an available amount of power of the charging module. In this way, the schedule can ensure that electric work vehicles do fall below a threshold state of charge. The schedule can also organise charging efficiently. For example, in an event that a vehicle is close to a charging module it may be efficient to charge the vehicle even if its state of charge of the battery is relatively high, so that it will not need to travel back to the charging module when it is further away, wasting time and charge.

Communicating charger properties to the electric work vehicle and communicating vehicle properties to the charging module may occur at the same time, or sequentially in either order. The charger properties and vehicle properties may be communicated continuously or at regular intervals. The charger properties and vehicle properties may alternatively be communicated on demand, for example in response to a request by a remote operator or a separate controller. The charger properties and vehicle properties may be communicated directly between the charging module and the electric work vehicle in addition to via a central controller 200.

The charging module and the electric work vehicle may each comprise a telematics module. The telematics modules may be configured to send and receive the charger properties and the vehicle properties.

The charging module may comprise a mains supply, or may not be connected to the mains supply. The charging module may comprise a power pack. The charger may comprise a generator.

Scheduling charging may be based on at least one of a priority assigned to each electric work vehicle; a state of charge of the battery of each electric work vehicle; a duration of charging required for each electric work vehicle; a proximity of each electric work vehicle to the charging module; and an available amount of charge of the charging module. Charging is more time consuming than charging a diesel electric work vehicle, for example, and so scheduling charging can take into account the expected duration of charging to avoid queues building up.

The charger properties may further comprise a health status of the charger. For example, whether the charger is working, and whether there is any damage to the charger or limited capability of the charger. The charger properties may further comprise a charging capacity of the charger. For example, in the event that the charger is not connected to the mains supply, it may have a limited amount of charge available. The charging capacity may comprise a state of charge of power pack. In an embodiment, the charging capacity may comprise either an indication that the charger has sufficient charge to fully charge the battery, or an indication of the predicted state of charge of the battery after fully draining the charger. The charger properties may further comprise a charging rate of the charger, and a charger connection type (such as DC, AC, or three phase).

The charger properties comprise an availability of the charging module. The availability of the charging module may comprise an indication of whether the charger is in use and a reservation status of the charger. For example, the charger may be currently in use, currently free, reserved for use at a certain time by another vehicle, or unreserved. In an event that the charger is in use, the availability of the charging module may further comprise a predicted charging end time at which the charger will be available. Similarly, in an event that the charger is reserved, the availability of the charging module may further comprise a period when the charger is free prior to the reservation and/or a predicted end time of the reservation.

The predicted charging end time may be calculated by the central controller based on a current state of charge of the battery being charged, a target state of charge of the battery being charged, and a charging rate of the charger. In an event that the charger is not connected to the mains supply, the charger properties may further comprise a predicted state of charge of the charger at the predicted charging end time.

In an embodiment, the charger may comprise a DC charger and the charger properties may further comprise a DC voltage of the charger.

The vehicle properties may further comprise a predicted time before charging is required. The predicted time may be based on at least one of a current state of charge, a discharge rate, and a distance from the charger. The discharge rate may be based on a current discharge rate. The discharge rate may be based on data from previous discharging of the battery, for example data comprising discharge rates at different states of charge, or discharge rates for the operator, or discharge rates for performing various tasks with the vehicle. The distance from the charger may be used to calculate the state of charge required to travel to the charger, and therefore the minimum state of charge that the vehicle can reach before needing to travel to the charger.

The vehicle properties may further comprise an available time period for charging. The available time may be based on a return-to-work time for the electric work vehicle. For example, the electric work vehicle may have a scheduled job before which it needs to be charged.

The vehicle properties may further comprise a target state of charge for charging. For example, the target state of charge may be to fully charge the battery to a 100% state of charge. The target state of charge may comprise a state of charge that has been determined to be appropriate to maintain good battery health. The target state of charge may be the state of charge required to complete the next task or the next shift.

The vehicle properties may further comprise at least one of a battery voltage, a maximum charge rate of the battery, a state of health of the battery, and a temperature of the battery.

The charging module may comprise a geofence. The geofence may define a perimeter around the charging module, for example based on a radius from the charging module. Within the geofence, a speed of the electric work vehicle may be limited to below a threshold speed, and/or the electric work vehicle may be limited in the tasks it can perform. There may be other limitations, such as the number of electric work vehicles permitted to be within the geofence at any one time The charger properties may further comprise the geofence and any limitations on the electric work vehicle that occur within the geofence.

In an embodiment, the step of bringing each electric work vehicle and its designated charging module together may comprise directing each electric work vehicle to its designated charging module. In another embodiment, the step of bringing each electric work vehicle and its designated charging module together may comprise directing the designated charging module to the electric work vehicle.

According to an embodiment of the present disclosure, a charging management device for a worksite comprising a plurality of autonomous electric work vehicles comprises a central controller. The charging management device is configured to communicate charger properties from a plurality of charging modules to a central controller and communicate vehicle properties from a plurality of electric work vehicles to the central controller. The charging management device is further configured to schedule charging for the plurality of electric work vehicle based on the charger properties and the vehicle properties. Scheduling charging comprises assigning to each of the electric work vehicles a designated charging time and a designated charging module, wherein the designated charging module is one of the plurality of charging modules. The charging management device is further configured to bring each electric work vehicle and its designated charging module together at designated charging time of the electric work vehicle. The charger properties comprise a location of the charging module and an availability of the charging module. The vehicle properties comprise a current state of charge of a battery of the electric work vehicle and a capacity of the battery of the electric work vehicle.

The charging management device may be configured to carry out any of the methods described above. The charging management device may comprise a telematics device on the charging module, and a telematics device on the electric work vehicle.

1. A method of charging management for a worksite comprising a plurality of autonomous electric work vehicles, the method comprising:
communicating charger properties from a plurality of charging modules to a central controller;
communicating vehicle properties from a plurality of electric work vehicles to the central controller;
scheduling charging for the plurality of electric work vehicles based on the charger properties and the vehicle properties, wherein scheduling charging comprises assigning to each of the electric work vehicles:
a designated charging time; and
a designated charging module, wherein the designated charging module is one of the plurality of charging modules; and
bringing each electric work vehicle and its designated charging module together at the designated charging time of the electric work vehicle;
wherein the charger properties comprise:
a location of the charging module; and
an availability of the charging module; and
wherein the vehicle properties comprise:
a current state of charge of a battery of the electric work vehicle; and
a capacity of the battery of the electric work vehicle; and
a predicted time before charging is required, based on a current state of charge and a discharge rate wherein the discharge rate is based on either a current discharge rate or on data from previous discharging of the battery.

2. The method of claim 1, wherein scheduling charging is based on at least one of:
a priority assigned to each electric work vehicle;
a state of charge of the battery of each electric work vehicle;
a duration of charging required for each electric work vehicle;
a proximity of each electric work vehicle to the charging module; and
an available amount of power of the charging module.

3. The method of claim 1, wherein the charger properties further comprise at least one of:
a health status of the charger;
a charging capacity of the charger;
a charging rate; and
a charger connection type.

4. The method of claim 1, wherein the availability of the charging module comprises at least one of:
an indication of whether the charging module is in use; and
a reservation status of the charging module.

5. The method of claim 1, wherein the vehicle properties further comprise at least one of:
a predicted time before charging is required;
an available time period for charging;
a target state of charge of the battery of the electric work vehicle.

6. The method of claim 1, wherein the vehicle properties further comprise at least one of:
a predicted time before charging is required;
an available time period for charging;
a target state of charge of the battery;
a battery voltage;
a maximum charge rate of the battery;
a state of health of the battery; and
a temperature of the battery.

7. The method of claim 1, wherein the step of bringing each electric work vehicle and its designated charging module together comprises directing each electric work vehicle to its designated charging module.

8. The method of claim 1, wherein the step of bringing each electric work vehicle and its designated charging module together comprises directing the designated charging module to the electric work vehicle.

9. The method of claim 1, wherein the step of bringing each electric work vehicle and its designated charging module together comprises a decision between directing each electric work vehicle to its designated charging module and directing the designated charging module to the electric work vehicle.

10. A charging management device for a worksite comprising a plurality of autonomous electric work vehicles, the charging management device comprising a central controller, wherein the charging management device is configured to:
communicate charger properties from a plurality of charging modules to a central controller;
communicate vehicle properties from a plurality of electric work vehicles to the central controller;
schedule charging for the plurality of electric work vehicles based on the charger properties and the vehicle properties, wherein scheduling charging comprises assigning to each of the electric work vehicles:
a designated charging time; and
a designated charging module, wherein the designated charging module is one of the plurality of charging modules; and
bring each electric work vehicle and its designated charging module together at the designated charging time of the electric work vehicle;
wherein the charger properties comprise:
a location of the charging module; and
an availability of the charging module; and
wherein the vehicle properties comprise:
a current state of charge of a battery of the electric work vehicle; and
a capacity of the battery of the electric work vehicle; and
a predicted time before charging is required, based on a current state of charge and a discharge rate wherein the discharge rate is based on either a current discharge rate or on data from previous discharging of the battery.

11. The charging management device of claim 10, wherein scheduling charging is based on at least one of:
a priority assigned to each electric work vehicle;
a state of charge of the battery of each electric work vehicle;
a duration of charging required for each electric work vehicle;
a proximity of each electric work vehicle to the charging module; and
an available amount of power of the charging module.

12. The charging management device of claim 10, wherein the charger properties further comprise at least one of:
a health status of the charger;
a charging capacity of the charger;
a charging rate; and
a charger connection type.

13. The charging management device of claim 10 wherein the availability of the charging module comprises at least one of:
an indication of whether the charging module is in use; and
a reservation status of the charging module.

14. The charging management device of claim 10, wherein the vehicle properties further comprise at least one of:
a predicted time before charging is required;
an available time period for charging; and
a target state of charge of the battery of the electric work vehicle.

15. The charging management device of claim 10, wherein the vehicle properties further comprise at least one of:
a predicted time before charging is required;
an available time period for charging;
a target state of charge of the battery;
a battery voltage;
a maximum charge rate of the battery;
a state of health of the battery; and
a temperature of the battery.
